(19) United States
(12) Patent Application Publication
(10) Pub. No.: US 2024/0086734 A1
(43) Pub. Date: Mar. 14, 2024

(54) MACHINE LEARNING PREDICTION OF REPAIR OR TOTAL LOSS ACTIONS

(71) Applicant: Mitchell International, Inc., San Diego, CA (US)

(72) Inventors: Mohnish Singh, San Diego, CA (US); Abhijeet Gulati, San Diego, CA (US); Sai Chaitanya Kanumalli, San Diego, CA (US)

(73) Assignee: Mitchell International, Inc., San Diego, CA (US)

(21) Appl. No.: 18/460,787

(22) Filed: Sep. 5, 2023

Related U.S. Application Data
(60) Provisional application No. 63/405,250, filed on Sep. 9, 2022.

(51) Int. Cl. G06N 5/022; G07C 5/08

(52) U.S. Cl. CPC G06N 5/022; G07C 5/0808

(57) ABSTRACT

Systems and methods are provided for a dynamic and iterative process for determining a weighted decision using a combination of weighted output from multiple, trained machine learning (ML) models. Key data can be identified and efficient decision-based processing can be achieved. In some examples, the system calculates a weighted decision of a repair or total loss determination for a motor vehicle, yet any industry or data set may be implemented with the use of the dynamic and iterative decision process.

### CROSS-REFERENCE TO RELATED APPLICATIONS

This application is a non-provisional patent application of U.S. Patent Application No. 63/405,250, filed Sep. 9, 2022, which is hereby incorporated by reference.

### BACKGROUND

Existing systems generate extensive amounts of data. With the extensive generation of data, the memory capacities of these existing systems tend to fill quickly and can make it difficult to identify key data. The key data is essentially hidden, which can negatively affect efficient and effective decision-based processing. Additionally, too much data results in too much noise and subjectivity in the data and compromises the performance and security of the system. Better systems and data management techniques are needed using improved technical solutions.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 a block diagram of an action prediction system with input devices, output devices, and a vehicle, in accordance with some embodiments of the disclosure.

FIG. 2 is a block diagram of functions implemented by the action prediction system, in accordance with some embodiments of the disclosure.

FIG. 3 is a flowchart of an exemplary method for determining a weighted decision using machine learning, in accordance with some embodiments of the disclosure.

FIG. 4 is a flowchart of an exemplary method for determining a weighted decision using machine learning, in accordance with some embodiments of the disclosure.

FIG. 5 are illustrative user interfaces for providing a display element associated with a weighted decision, in accordance with some embodiments of the disclosure.

FIG. 6 is an example computing component that may be used to implement various features of embodiments described in the present disclosure.

The figures are not exhaustive and do not limit the present disclosure to the precise form disclosed.

### DETAILED DESCRIPTION

Examples described herein can comprise a dynamic and iterative process for determining a weighted decision using a combination of weighted output from multiple, trained machine learning (ML) models. Key data can be identified, and efficient and effective decision-based computational processing can be achieved. In turn, examples of the systems and methods described herein can provide a better technical solution using an improved machine learning process to offer efficient and effective decision-based computational processing.

In examples provided throughout the disclosure, the weighted decision identifies a repair or total loss determination for a motor vehicle, yet any industry or data set may be implemented with the use of the dynamic and iterative decision process. For example, the system receives a plurality of data (e.g., image or video data, vehicle data, telematics data, and triage data responding to a state of the motor vehicle determined by an observer of the motor vehicle) and provides it to the system. The system can provide the data to multiple ML models for each category of data and weight the output from the ML models to provide in initial repair or total loss determination. Based on the initial determination, the system can select a first question for the user in the triage process (e.g., were the airbags deployed, is the vehicle drivable, etc.). When the system receives an answer, the system can provide it to the trained ML models to determine a second repair or total loss determination. Each repair or total loss determination may be associated with a confidence score. Once the confidence score for a particular repair or total loss determination exceeds a confidence threshold, the system provides the repair or total loss determination to the user. The interactive process can be implemented as a standalone computer system or “as-a-Service” in the cloud (e.g., in a hosted backend system).

In some examples, the initial determination process may be directed to users (e.g., claimants, policyholders, insured users, etc.) to make a repair or total loss determination. The question-answer data may not be provided as input to the system.

In some examples, the question-answer data may be included in the initial set of the plurality of data about the motor vehicle and subsequently removed. For example, the question-answer data may be removed as input to the ML model and determinations from image or video input may be supplemented as input to the ML model. In some examples, the system may remove question-answer data from the input that is applied to the set of trained machine learning models for individual categories and supplement determinations from the one or more image or video as the input that is applied to the set of trained machine learning models for individual categories.

In some examples, the question-answer data may be based on an auto-fill of the responses (e.g., using ML computer vision). As an illustrative example, the system may determine whether the airbags deployed using a question-answer prompt to the user or image-based computer-vision (CV) model to detect airbags in the images/videos and autofill the response (e.g., yes/no). In another illustrative example, the system may determine whether the vehicle is drivable using a question-answer prompt to the user or detecting suspension and front vehicle damage using a machine learning model, for example, a vehicle collision damage-specific computer vision model, and auto-fill the response (e.g., yes/no) based on the output of the model. Even without some of the types of input data, the systems and methods described herein can generate a repair or total loss determination.

In some examples, the system may automatically predict a repair or total loss determination of a motor vehicle involved in a motor vehicle accident. The method may comprise, for example, receive a plurality of data and initiate a data imputation process to supplement the plurality of data; for individual categories of the plurality of data, determine a categorization and a confidence score by applying the plurality of data as input to a set of trained machine learning models for each category; determine a weighted decision for multiple categories that combines the categorization and the confidence score; select a question of a set of questions based on the weighted decision and provide the question to a graphical user interface (GUI); upon receiving a response to the question via the GUI, provide the response to the set of trained machine learning models, wherein output from the set of trained machine learning models iteratively adjusts the confidence score for each category and the weighted decision; and when the weighted decision exceeds a confidence threshold, update the GUI to present information associated with the weighted decision. In some examples, the data are provided to a GUI that displays information associated with the weighted decision.

In some examples, the system and method may generate a decision that determines a repairable versus total loss vehicle damage classification based on aggregation of model inputs. The aggregation of model inputs may include damage triage questionnaire details, context driven image artifacts and/or video stream which infers damage recognition to various parts/panel of the vehicle, along with vehicular metadata (out of VIN and derivative information like ACV, mileage etc.). The triage may combine signals from various models (machine learned, statistical, and Image-based CV models) that have been trained on different datasets and aggregating them to produce classification of repair versus total loss decision along with a confidence score. In some examples, internal, external, or third party machine learning models can be combined/aggregated to generate an aggregated decision/output. The models may be trained on different datasets, and the set of trained models may correspond to individual categories. When this is implemented, the set of trained models may comprise at least two of machine learned, statistical, and image-based CV models that are trained on different datasets. In some examples, machine driven learning process may incorporate various coverage or loss types (e.g., collision, liability, comprehensive, fire, or theft) and identify the categories for different vehicle types and subtypes.

In some examples, specific questions may be provided to users to answer based on coverage or loss types. For example, there may be certain questions that apply only to “fire” loss type and may not apply to “collision” loss type. As an illustrative example, a first question may recite “What was the cause of the damage?” If the user answers “collision”, the system may execute instruction-based business rules that can provide a set of additional questions related to the cause of the damage. If the user answers “fire,” the system may execute instruction-based business rules that can provide a second set of additional questions related to the different cause of the damage. There may be questions that apply to fire and not collision and vice-versa, or may apply to both categories or neither category.

The disclosed technology has a number of advantages including providing methods, non-transitory computer readable media, and insurance claim analysis devices that improve machine learning and reduce memory requirements for the system. Examples of the disclosure can facilitate improved accuracy, consistency, and efficiency with respect to analyzing images, video, and data associated with insurance claims to automatically recommend repair or total loss of a vehicle involved in an accident. This technology advantageously utilizes machine learning models to automatically analyze multiple sources of data to reduce the amount of data overall that is needed by the system. The lesser used data may offer more efficient processing and effective processor performance for the devices that are executing the ML models described herein. Data are reused across multiple decision processes, allowing the system overall to use less memory and process at a faster rate with fewer computations.

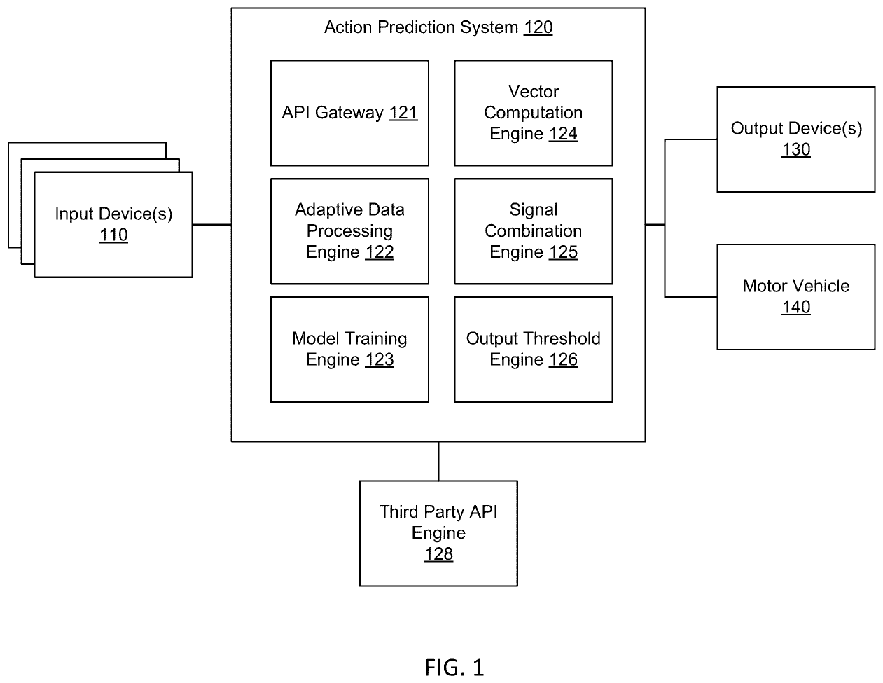

FIG. 1 a block diagram of an action prediction system with input devices, output devices, and a vehicle, in accordance with some embodiments of the disclosure. In this example, input devices 110 provide input data associated with a motor vehicle accident to action prediction system 120, which generates a categorization and confidence score associated with the motor vehicle accident for output device(s) 130 or vehicle 140. Input device(s) 110, action prediction system 120, output device(s) 130, and vehicle 140 may communicate through a communication network, which can include Wi-Fi®, local area network(s) (LAN(s)), or wide area network(s) (WAN(s)), and can use TCP/IP over Ethernet and industry-standard protocols, although other types and/or numbers of protocols and/or communication networks can be used.

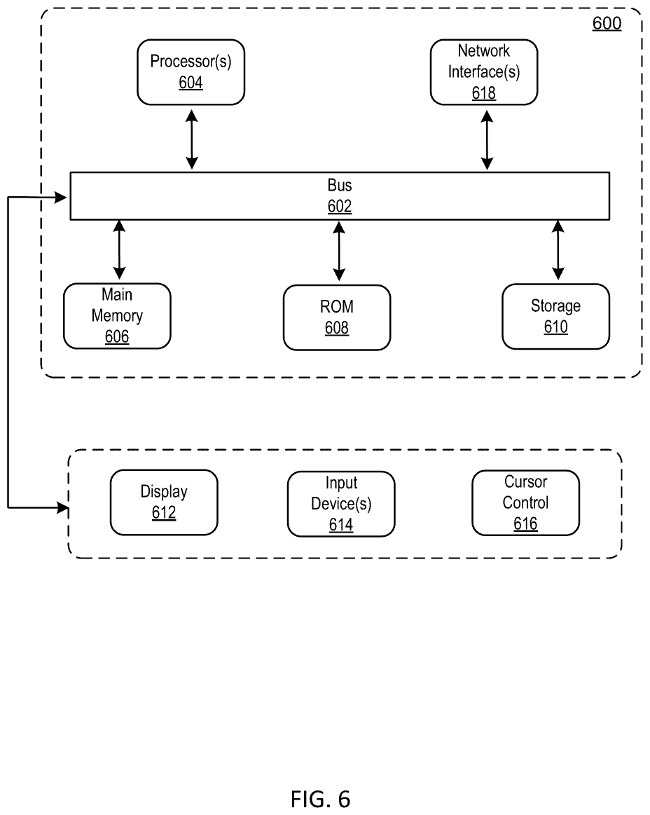

Action prediction system 120 in this example includes processor(s), memory, and a communication interface, which are coupled together by a bus or other communication link. An illustrative example of these components are provided in FIG. 6.

The processor(s) of action prediction system 120 may execute programmed instructions stored in the memory for the any number of the functions described and illustrated herein. The processor(s) may include one or more CPUs or general purpose processors with one or more processing cores, for example, although other types of processor(s) can also be used.

The memory stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) can be used for the memory.

Accordingly, the memory can store application(s) that can include executable instructions that, when executed by action prediction system 120, cause action prediction system 120 to perform the actions described herein. The application(s) can be implemented as modules or components of other application(s). Further, the application(s) can be implemented as operating system extensions, module, plugins, or the like. Even further, the application(s) may be operative in a cloud-based computing environment. The application(s) can be executed within or as virtual machine(s) or virtual server(s) that may be managed in a cloud-based computing environment. Also, the application(s), and even action prediction system 120 itself, may be located in virtual server(s) running in a cloud-based computing environment rather than being tied to one or more specific physical network computing devices. Also, the application(s) may be running in one or more virtual machines (VMs) executing on action prediction system 120. Additionally, in one or more embodiments of this technology, virtual machine(s) running on action prediction system 120 may be managed or supervised by a hypervisor.

In this particular example, action prediction system 120 can comprise API gateway 121, adaptive data processing engine 122, model training engine 123, vector computation engine 124, signal combination engine 125, and output threshold engine 126. In some examples, any of these engines may communicate with third party API services, as illustrated as third party API engine 128. Third party API engine 128 may receive input from any one of API gateway 121, adaptive data processing engine 122, model training engine 123, vector computation engine 124, signal combination engine 125, and output threshold engine 126, and provide an output response based on processing implemented internally to third party API engine 128. The output provided by third party API engine 128 may be incorporated with processing and functions performed by the components of action prediction system 120.

API gateway 121 is configured to provide an interface between various devices and action prediction system 120. For example, the user may access an interface to upload a plurality of data as input to action prediction system 120. The plurality of data may comprise images and/or video stream of a motor vehicle involved in a motor vehicle accident, vehicle data describing categorization of the motor vehicle, telematics data recorded within a threshold of time of the motor vehicle accident, and triage data responding to a state of the motor vehicle determined by an observer of the motor vehicle. In another example, data may be provided via API gateway 121 at multiple times throughout the process.

API gateway 121 is also configured to update a GUI to present information associated with the weighted decision. For example, the information may be provided “as-a-Service” in the cloud (e.g., in a hosted backend system) in response to receiving a plurality of data. The information can include, for example, a repair or total loss determination that exceeds a confidence threshold. In this example, a user device may access API gateway 121 via a network connection and transmit the data. Action prediction system 120 may process the request and provide information associated with the weighted decision back to the user device via API gateway 121.

Adaptive data processing engine 122 is configured to initiate a data imputation process to supplement the plurality of data. For example, data may be stored in accordance with its category type. In some examples, the user may identify the category of the plurality of data received by action prediction system 120 and the category may be stored as metadata with the input file (e.g., by selecting a category from a set of categories at the interface, etc.). In some examples, the file type may be analyzed by adaptive data processing engine 122 to determine the category (e.g., jpeg file types correspond with images, etc.). When the file type matches a predetermined list of file types stored in a data dictionary, the category of the data may be stored as the definition of the file in the data dictionary.

Adaptive data processing engine 122 is also configured to provide questions to the interface (e.g., as part of a questionnaire). For example, adaptive data processing engine 122 may select a first question of a set of questions. The first question may be selected as a default question or based on a weighted decision by the system. The first question may be provided to a graphical user interface (GUI) or other interface. When the interface receives a response, the response can be provided to a machine learning model. A second question of the set of questions may be selected based on output from the machine learning model or updated weighted decision.

Model training engine 123 is configured to determine a categorization and a confidence score by applying the plurality of data as input to a set of trained machine learning models for individual categories. Various categorizations may be implemented, including a ML model type categorization and a ML model output categorization.

As an illustrative example, the categories corresponding with the ML model output categorization may comprise Repairable, Borderline/probable repairable, Borderline/Probable total loss, and total loss, with each category corresponding with a confidence score. The categories corresponding with the ML model type categorization may comprise output from various internal or external systems or an identification of the internal or external system that generates or analyzes data as part of a larger and broader process. The systems may include, for example, a vehicle collision damage-specific computer vision model/system. Other examples of these systems may include a Mitchell Intelligent Damage Analysis (MIDA) model, a Vehicle Metadata Model (VMM), a Claim level Model (CLM), a Damage Triage Evaluation (DTE) model. Within DTE, sub-ML models may be implemented for different coverage or loss types. The categories corresponding with the ML model type categorization may vary by the input data (e.g., questionnaire data corresponds with DTE models) and each of the ML systems may use a different combination of input data and datasets. For example, the models can be trained on different datasets, and the set of trained models may correspond to individual categories, such that the set of trained models may comprise at least two model types and these models that are trained on different datasets. For each of these categorization examples described herein, further partitions and selections of these categorizations may be selected from a set of available categorizations. The determination of the confidence score may be based on applying the plurality of data as input to the trained machine learning models for individual categories associated with for individual category.

The machine learning models may include a feature extraction layer that extracts features from the plurality of data (e.g., image or video data, vehicle data, telematics data, or triage data). In some embodiments, this process may be performed after preprocessing the plurality of data. The preprocessing may include input data transformation. The plurality of data transformation may include converting different file types (e.g., image or video format, word format, etc.) into a unified digital format (e.g., pdf file). The preprocessing may include data extraction. The data extraction may include discarding extracting useful information, for example using optical character recognition (OCR), Generative AI, computer vision, deep learning, and natural language processing (NLP) techniques.

The feature extraction in the feature extraction layer may be performed against the extracted data. Examples of features for extraction could include damage illustrated in an image or video, a yes/no response, a categorical response (e.g., identifying a location of the primary point-of-impact or specific location like “right/rear” or “front/center”), or any other relevant information present in the plurality of data.

The selection of the features for extraction may also be determined by learning weights or importance scores for the candidate features using a tree-based machine learning model. For example, the tree-based machine learning model for feature selection may use Random Forests or Gradient Boosting. The model includes an ensemble of decision trees that collectively make predictions. To begin, the tree-based model may be trained on a labeled dataset (e.g., image or video data, vehicle data, telematics data, and triage data). The labels may comprise total loss, partial loss, or repairable labels. The labels may be used to train the tree-based machine learning model, such that the selected features can efficiently and accurately predict the actions.

As the tree-based machine learning model learns to make predictions, it recursively splits the data based on different features, constructing a tree structure that captures patterns in the data. One of the advantages of tree-based models is that they can generate feature importance scores for each input feature. These scores reflect the relative importance of each feature in contributing to the model's predictive power. A higher importance score indicates that a feature has a greater influence on the model's decision-making process.

In some embodiments, Gini importance metric may be used for feature importance in the tree-based model. Gini importance quantifies the total reduction in the Gini impurity achieved by each feature across all the trees in the ensemble. Features that lead to a substantial decrease in impurity when used for splitting the data may be assigned higher importance scores.

Once the tree-based model is trained, the feature importance scores may be extracted. By sorting the features in descending order based on their scores, a ranked list of features may be obtained. This ranking enables prioritizing the features that have the most impact on the model's decision-making process. Based on the feature ranking, the top features may be extracted from an incoming response to a question about a damaged vehicle (or other data as described herein) and fed into the machine learning model to generate a confidence score for comparing with a range of values that determines a total loss, repairable, or other designation for the vehicle.

Model training engine 123 is also configured to train the model in multiple stages. For example, in a linear machine learning model, the first stage may train the machine learning model by initializing the model parameters to random values or zeros. As the training progresses during the first stage, the model parameters may be updated using the training data set to minimize the objective function (e.g., using gradient descent) in order to determine the weights of the model. A second stage may follow the first stage of the training and use of the trained machine learning models. The second stage may comprise creating a second training set, and training the trained machine learning models using the second training set. The second training set may include the inputs applied to the machine learning models, and the corresponding outputs generated by the machine learning models, during actual use of the machine learning models. The second training stage may include identifying erroneous assessments generated by the machine learning model, and adding the identified erroneous assessments to the second training set. Creating the second training set may also include adding the inputs corresponding to the identified erroneous assessments to the second training set. Other data or components are available without diverting from the essence of the disclosure.

In some examples, the training may include supervised learning with labeled training data (e.g., historical inference input with two layers of labels for training purposes). As explained above, the first layer of labels may be used to train a feature selection tree-based machine learning model to determine the key features to extract from the plurality of data. After the key features are determined, the first layer of labels may be used again to train the feature embedding layer (that embeds the extracted features into numeric vectors) as well as a classification output branch. The second layer of labels may be used to jointly train the feature embedding layer as well as a regression output branch. The training may be performed iteratively. The training may include techniques such as forward propagation, loss function, backpropagation for calculating gradients of the loss, and updating weights for each input.

As discussed herein, the training may include a stage to initialize the model. This stage may include initializing parameters of the model, including weights and biases, and may be performed randomly or using predefined values. The initialization process may be customized to suit the type of model.

The training may include a forward propagation stage. This stage may include a forward pass through the model with a batch of training data. The input data may be multiplied by the weights, and biases may be added at each layer of the model. Activation functions may be applied to introduce non-linearity and capture complex relationships.

The training may include a stage to calculate loss. This stage may include computing a loss function that is appropriate for binary classification, such as binary cross-entropy or logistic loss. The loss function may measure the difference between the predicted output and the actual binary labels.

The training may include a backpropagation stage. Backpropagation involves propagating error backward through the network and applying the chain rule of derivatives to calculate gradients efficiently. This stage may include calculating gradients of the loss with respect to the model's parameters. The gradients may measure the sensitivity of the loss function to changes in each parameter.

The training may include a stage to update weights of the model. The gradients may be used to update the model's weights and biases, aiming to minimize the loss function. The update may be performed using an optimization algorithm, such as stochastic gradient descent (SGD) or its variants (e.g., Adam, RMSprop). The weights may be adjusted by taking a step in the opposite direction of the gradients, scaled by a learning rate.

The training may iterate. The training process may include multiple iterations or epochs until convergence is reached. In each iteration, a new batch of training data may be fed through the model, and the weights adjusted based on the gradients calculated from the loss.

The training may include a model evaluation stage. Here, the model's performance may be evaluated using a separate validation or test dataset. The evaluation may include monitoring metrics such as accuracy, precision, recall, and mean squared error to assess the model's generalization and identify possible overfitting.

The training may include stages to repeat and fine-tune the model. These stages may include adjusting hyperparameters (e.g., learning rate, regularization) based on the evaluation results and iterating further to improve the model's performance. The training can continue until convergence, a maximum number of iterations, or a predefined stopping criterion.

Vector computation engine 124 is configured to provide the response to the set of trained machine learning models. The response may be received to a question, where output from the set of trained machine learning models iteratively adjusts the confidence score for each category and the weighted decision.

In some examples, the machine learning model may include multiple output branches: a first branch for generating a confidence score for comparing with a range of values that determines a total loss, repairable, or other designation for the vehicle, and a second branch for determining a second or subsequent question for the triage process for assessing damage to a motor vehicle. The first branch may be a regression branch because its output variable is a continuous numerical value (the confidence score estimate), as opposed to discrete class labels in the classification branch (which action to perform). The second branch may be a classification branch, which may include a sigmoid activation function to output a percentage for each of the possible questions to select/present to the user interface. These two branches are jointly trained, and share the same feature embedding layer (for weighting the key features) but may have separate convolution layer(s) (for extracting the latent relationships between the key features and the outputs).

Signal combination engine 125 is configured to determine a weighted decision for individual categories that combines the categorization and the confidence score. The categories of data may be combined in a weighted decision. For example, the four categories may have equal weights so that when the categorization for a majority of the categories is total loss and the corresponding confidence score for those categories exceeds a threshold value for each category, the weighted decision that combines the categorization and the confidence scores for each category of the plurality of data may also equal total loss (e.g., corresponding with the majority). In another example of equal weights, when the categorization for a majority of the categories is repairable (e.g., not total loss) and the corresponding confidence score for those categories exceeds a threshold value for each category, the weighted decision that combines the categorization and the confidence scores for each category of the plurality of data may also equal repairable (e.g., corresponding with the majority).

Other weighted decisions may be determined, such that one determination (e.g., categorization and confidence score) could outweigh or correspond with an increased weight in comparison with the other determinations. For example, a first category (e.g., image or video data) may be the default determination of total loss or repairable when the confidence score exceeds a threshold. In other examples, the first category (e.g., image or video data) may be the default determination of total loss or repairable only when the confidence scores of the other categories fail to exceed a threshold. In still other examples, the aggregation of the second category (e.g., vehicle data), third category (e.g., telematics data), and fourth category (e.g., triage data) may be used when the confidence score exceeds a threshold value for the first category (e.g., image or video data). In some examples, a user can configure features of the weighted decisions, including a rank order and weight of certain ML decisions. The configuration may adjust the category of ML models (e.g., weigh the decision from Image Data higher than Vehicle Data which will be higher than Triage Data). In some examples, the system can receive the rank order and weight of the individual categories that adjusts the weighted decision for the individual categories. Various implementation details are possible.

The weighted decision may be determined by votes. The votes may be configured to adjust one or more thresholds corresponding to each data category or determine which input categories are determinative of a total or partial loss, or a repairable component of the motor vehicle that does not exceed a total value of the motor vehicle. In some examples, the entire or partial process may be adjusted or updated when the ML model is retrained to incorporate newer data, improve system processing performance, or triggered at particular times.

The weighted decisions may correspond with a profile. The profile may be selectable or otherwise associated with a user operating the system. The profile may determine which category is weighted higher than other categories or other features, including the threshold value for each category or what requirements are needed to generate the ultimate weighted decision that combines the categorization and the confidence score for each category of the plurality of data. In some examples, the system may receive the profile that adjusts the individual categories to affect the weighted decision. The rank order may be implemented to adjust the weighted decisions for various ML outcomes from either the category of ML models (e.g., weigh the decision from Image Data higher than Vehicle Data which will be higher than Triage Data).

Output threshold engine 126 is configured to select a question of a set of questions based on the weighted decision and provide the question to a graphical user interface (GUI).

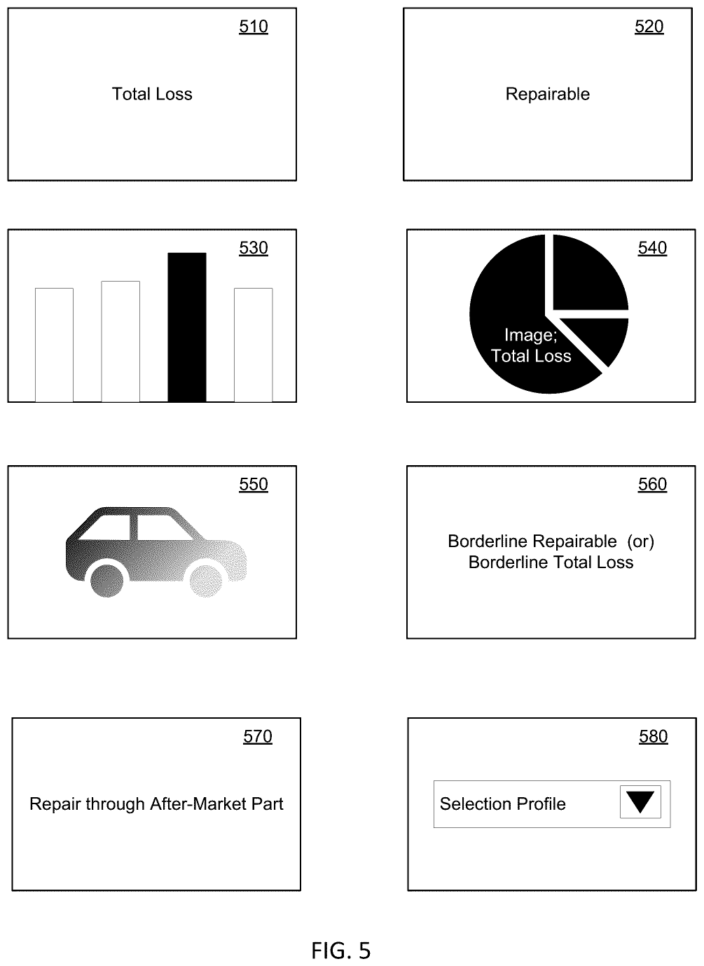

Output threshold engine 126 is also configured to, when the weighted decision exceeds a confidence threshold, update the GUI to present information associated with the weighted decision. Illustrative examples of this information is provided with FIG. 5.

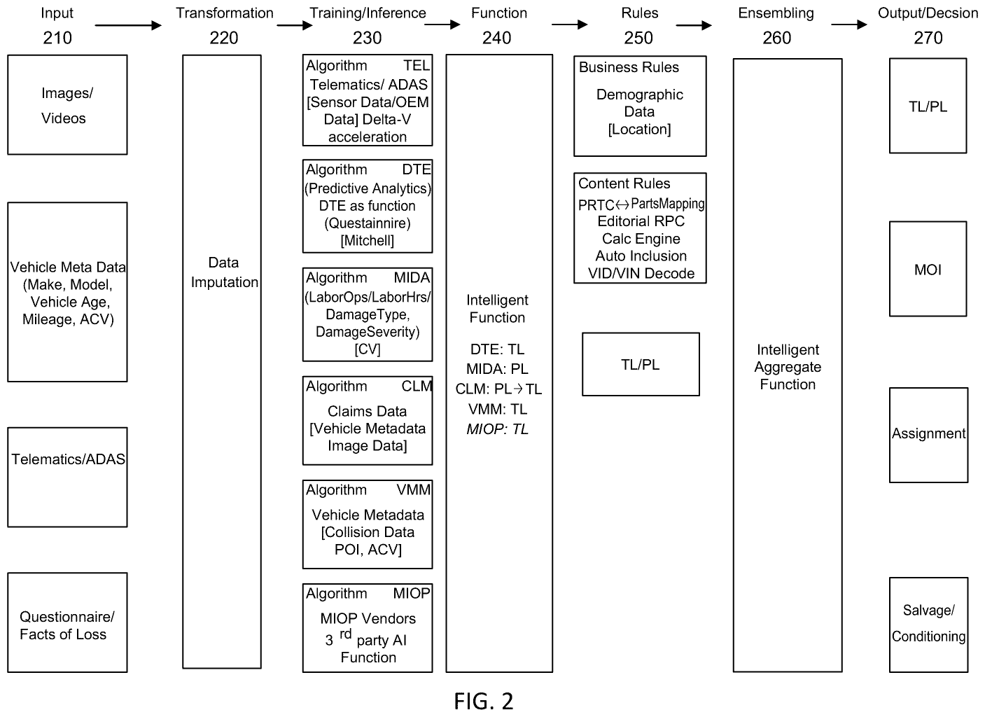

The engines and components of action prediction system 120 may perform the functions illustrated in FIG. 2. The elements of FIG. 2 are presented in one arrangement. It should be understood that one or more elements of the process may be performed in a different order, in parallel, omitted entirely, and the like. The other elements in addition to those presented may be implemented and, in some examples, elements may be added to implement error-handling functions if exceptions occur, and the like.

At block 210 of FIG. 2, input is received by API gateway 121 and may comprise a plurality of data in different categories. Adaptive data processing engine 122 may determine the categories. The categories may include, for example, one or more images/videos of a motor vehicle involved in a motor vehicle accident, vehicle data describing categorization of the motor vehicle, telematics data recorded within a threshold of time of the motor vehicle accident, and triage data responding to a state of the motor vehicle determined by an observer of the motor vehicle.

Images/videos of a motor vehicle involved in a motor vehicle accident may comprise still or moving images or video of the vehicle that captures the visual status of the vehicle from multiple angles.

Vehicle data describing the categorization of the motor vehicle may comprise make, model, vehicle age, mileage, estimated value, or other object data of the vehicle components. In some examples, market value of the vehicle and salvage value of the vehicle may also be received from a data source.

Market value or salvage value of the vehicle may be incorporated with the system, and in some cases, may increase a weight of a decision toward repairable with a market value over a threshold value. For example, the system may determine a “near real-time” market value or Kelley Blue Book value of the vehicle. A waterfall or cascading logic process may be implemented to determine value to choose (e.g., market value ACV or book value ACV). Using either value determination, if estimate amount is higher than market value, it could be a total loss, else it could be repairable. Salvage value may correspond with a value that an owner/insurer can recuperate from selling the vehicle after paying the user for the claim. Higher salvage can correspond with recuperating higher costs if a vehicle is deemed a total loss. As an illustrative example, Market value=25,000, Estimate Amount=20,000, and Salvage=$7000. The carrier may decide to render this a total loss. In another illustrative example, Market value=27,000, Estimate Amount=20,000, and Salvage=$1000. The carrier may decide to render this as a repairable. Any of these determinations may be incorporated with the business rules and other processing determinations of the system.

Telematics data may comprise sensor data associated with the vehicle around the time of the motor vehicle accident, including traveling velocity (e.g., Delta-v), direction, location from a positioning system, or other data measured by the motor vehicle or surrounding structure.

Triage data may correspond with responses to a questionnaire or user input associated with facts of loss of the motor vehicle. For example, triage data may be based on a series of questions that are answerable by an observer of the motor vehicle. The questions may include, for example, whether the motor vehicle is drivable, whether fluids are leaking, whether airbags were deployed, or other questions that would need a visible observation and analysis of the motor vehicle. The questions used to generate the triage data may be selected from a pre-existing question data store associated with an insurance carrier and reduced to a predetermined set of questions.

In some examples, the predetermined set of questions is iteratively adjusted by adaptive data processing engine 122 to narrow the range of responses from the observer of the motor vehicle and help increase accuracy of the response. For example, the original set of questions may include thirty questions and the system may identify that after asking ten questions, adding any more questions does not necessarily give more accuracy without negatively impacting user experience. The predetermined set of questions may be reduced to ten questions and reordered to ask more important questions earlier, in anticipation of the later questions not being answered.

In some examples, the questions may be used to train a machine learning model by model training engine 123. The questions may be normalized or otherwise processed through a natural language processing (NLP) or Generative-AI, and redrafted from the pre-existing question data store to provide to the observer of the motor vehicle to generate the responses. One or more responses may utilize the context that the motor vehicle is in to generate additional triage data.

Various machine learning models may be used. For example, the machine learning models and techniques may include classifiers, decision trees, neural networks, gradient boosting, and similar machine learning models and techniques. The machine learning models may be trained previously according to historical correspondences between input parameters and corresponding assessments. The input parameters may include those described above, for example such as validated diagnostic code, the one of the plurality of parts, and the categorization table. Once the machine learning models have been trained, new input parameters may be applied to the trained machine learning model as inputs. In response, the machine learning models may provide the assessments as outputs.

Some embodiments include the training of the machine learning models by model training engine 123 in FIG. 1. The training may be supervised, unsupervised, or a combination thereof, and may continue between operations for the lifetime of the system. The training may include creating a training set that includes the input parameters and corresponding assessments described above.

At block 220, input data may be provided to a data imputation module to initiate a data imputation process. The data imputation process may supplement the input data with additional information. In some examples, the data imputation process may add information that was not available within a threshold amount of time that the motor vehicle accident occurred (e.g., within 2 hours). The data imputation process may add data at a later time when the data was not originally retrievable.

In some examples, the data imputation process may process the predetermined set of questions. For example, insurance carrier A may ask “Are you able to open/close the doors” and insurance carrier B may ask “Are you able to get inside the vehicle”? The data imputation process may combine the questions where the intent of asking the question to receive a particular response or the intent behind the question is similar. The data imputation process may consider the responses to these questions as if they are same questions despite the questions being different, being from two consumers, having relationship with two separate insurance carriers, or the user interfaces providing two different questions.

At block 230, a training or inference function may be implemented. For example, model training engine 123 may train a set of machine learning models. Once the machine learning models have been trained, a response to a presented question may be received and provided to the machine learning model to generate an output and iteratively adjust the confidence score for each category and the weighted decision.

At block 240, an intelligent function may be implemented. For example, if each of the ML systems/processes are implemented, multiple independent assessments can be received regarding the repair or total loss determination. The intelligent function may aggregate or ensemble the independent assessments to provide a single decision with a confidence score, as shown with block 260.

In some examples, information may be integrated from an external or other third party system that separately and distinctly implement additional ML models to generate a repair or total loss determination. This may incorporate an additional ML system with the five independent assessments generated previously. In this illustration, the external system may show a “total loss” determination that is weighted with the independent assessments described herein.

At block 250, one or more business rules or content rules may be added. For example, the business rules may comprise limitations and features of the input data (e.g., state of origin increasing a value of repair or total loss for the location). The market value, salvage value, repairable state of vehicle, or other considerations determined using images, video, or other input data may correspond with these rules. In other examples, the business rules may incorporate flexibility to allow for human judgement as an input for flexibility in determining borderline categories. Carriers, based on their business rules, can use borderline decisions to update borderline repairable to Total loss and borderline total loss to repairable. If the carrier network shop does not have bandwidth to repair a borderline repairable vehicle due to existing volume, they may decide to convert borderline repairable to a total loss, and vice versa. Other customizations to business rules may be implemented to increase flexibility for the system and processes described herein.

At block 260, the output may be ensembled or aggregated. For example, when the output comprises a confidence value associated with a category, the confidence values can be ensembled or aggregated. As an illustrative example, a machine learning model associated with a first category may provide a first value (e.g., 0.5) and a machine learning model associated with a second category may provide a second value (e.g., 0.7), then the first and second values can be averaged to generate a new value (e.g., 0.6). In another illustrative example, a machine learning model associated with a first category may provide a first value (e.g., 0.5) and a machine learning model associated with a second category may provide a second value (e.g., 0.7), the first value may be chosen based on a historical identification that the machine learning model associated with a first category determines a correct answer more frequently (e.g., 0.5).

At block 270, an output or decision may be provided. For example, the output or decision may correspond with a range of values between total loss, partial loss or repairable damage, and no damage. Other values may be implemented as well, including borderline repairable and borderline total loss. To determine these output values, a range or threshold may be associated with the maximum or minimum acceptable value for each decision.

In some examples, the weighted value may be compared with a confidence margin threshold. Based on the comparison, the system may determine a second category associated with the weighted decision.

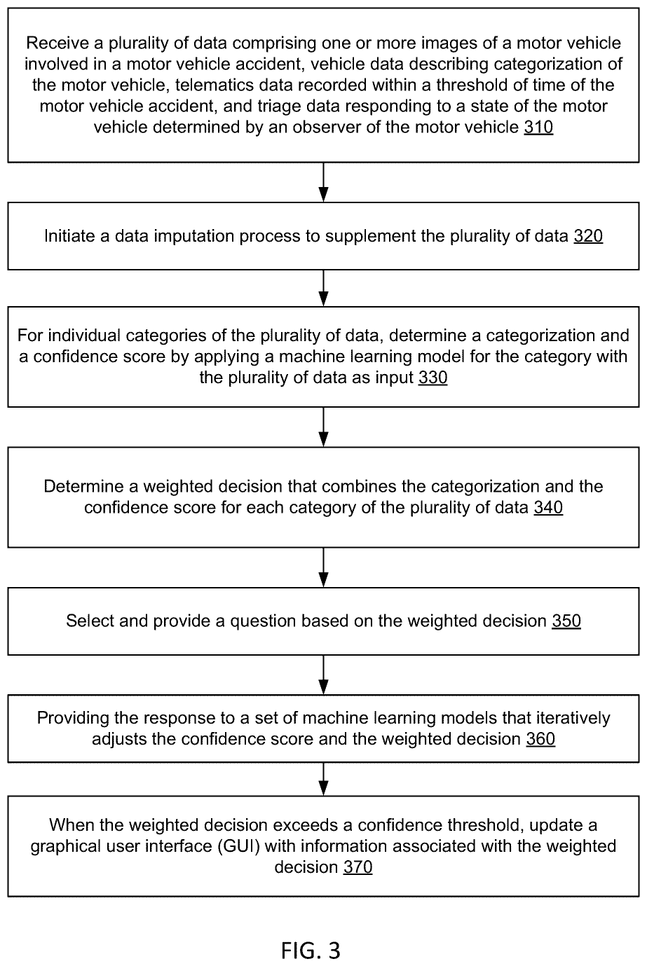

FIG. 3 is a flowchart of an exemplary method for determining a weighted decision using machine learning, in accordance with some embodiments of the disclosure. The illustrative method provided in FIG. 3 may be implemented by action prediction system 120 of FIG. 1.

The elements of FIG. 3 are presented in one arrangement. However, it should be understood that one or more elements of the process may be performed in a different order, in parallel, omitted entirely, and the like. The other elements in addition to those presented may be implemented and, in some examples, elements may be added to implement error-handling functions if exceptions occur, and the like.

At block 310, the method may receive a plurality of data by adaptive data processing engine 122 of action prediction system 120 in FIG. 1. For example, the data may comprise one or more images or video data, vehicle data, telematics data, and triage data.

At block 320, the method may initiate a data imputation process to supplement the plurality of data by adaptive data processing engine 122 of action prediction system 120 in FIG. 1.

At block 330, for individual categories of the plurality of data, the method may determine a categorization and a confidence score by applying a machine learning model for the category with the plurality of data as input. The process may be performed by vector computation engine 124 of action prediction system 120 in FIG. 1.

Various machine learning models may be used. For example, the machine learning models and techniques may include classifiers, decision trees, neural networks, gradient boosting, and similar machine learning models and techniques. The machine learning models may be trained previously according to historical correspondences between examples of the inputs and outputs. The training may be supervised, unsupervised, or a combination thereof, and may continue between operations for the lifetime of the system. Outputs of the models may be used to train the models again, for example to improve their accuracy. The model may be trained and revised, as discussed with FIGS. 1-2.

Various illustrative examples of determining a categorization and a confidence score by applying a machine learning model are provided herein. For example, the output of the machine learning model may determine, in accordance with a confidence score, whether a first category of input data (e.g., image/video data) identify that the motor vehicle is considered a total loss or repairable for the first category. When the confidence score for that category exceeds a threshold value for the first category, the motor vehicle may be determined to be a total loss or repairable for the first category of data. In another example, the output of the machine learning model may determine, in accordance with a confidence score, whether a second category of input data (e.g., vehicle data) identify that the motor vehicle is considered a total loss or repairable for that second category. When the confidence score for the second category exceeds a threshold value for the second category, the motor vehicle may be determined to be a total loss or repairable for the second category of data. In another example, the output of the machine learning model may determine, in accordance with a confidence score, whether a third category of input data (e.g., telematics data) identify that the motor vehicle is considered a total loss or repairable for the third category. When the confidence score for that category exceeds a threshold value for the third category, the motor vehicle may be determined to be a total loss or repairable for the third category of data. In another example, the output of the machine learning model may determine, in accordance with a confidence score, whether a fourth category of input data (e.g., triage data) identify that the motor vehicle is considered a total loss or repairable for the fourth category. When the confidence score for that category exceeds a threshold value for the fourth category, the motor vehicle may be determined to be a total loss or repairable for the fourth category of data.

At block 340, the method may determine a weighted decision that combines the categorization and the confidence score for each category of the plurality of data, using signal combination engine 125 of action prediction system 120 in FIG. 1.

At block 350, the method may select and provide a question based on the weighted decision by adaptive data processing engine 122 of action prediction system 120 in FIG. 1.

At block 360, the method may provide the response to a set of machine learning models that iteratively adjusts the confidence score and the weighted decision by adaptive data processing engine 122 of action prediction system 120 in FIG. 1.

At block 370, the method may provide information associated with the weighted decision by adaptive data processing engine 122 of action prediction system 120 in FIG. 1. For example, a graphical user interface (GUI) comprising a display element may represent the information associated with the weighted decision. In some examples, the information associated with the weighted decision may be provided via the API gateway.

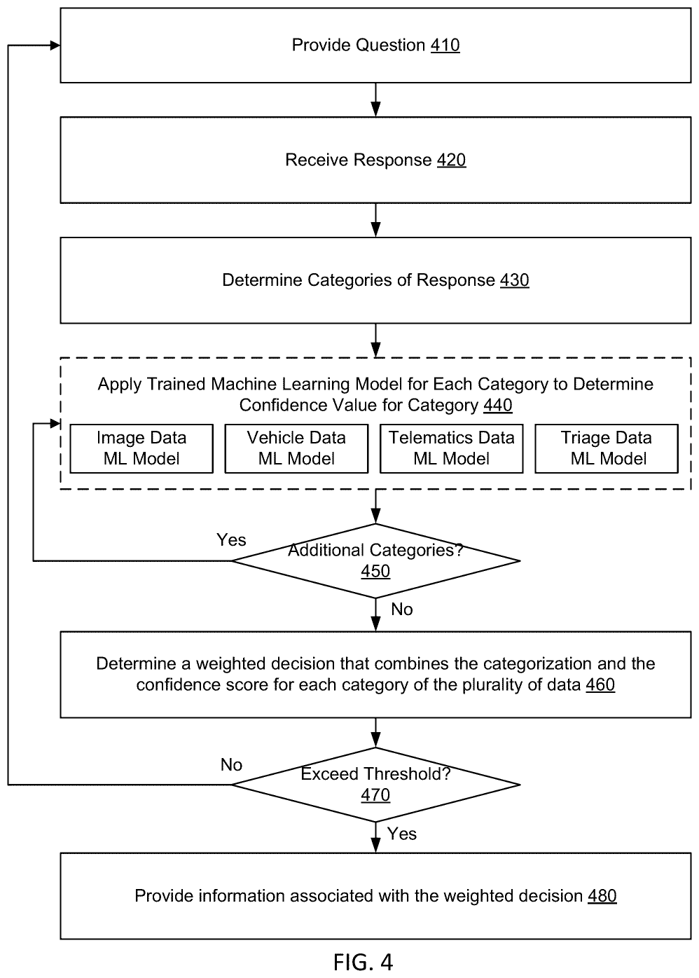

FIG. 4 is a flowchart of an exemplary method for determining a weighted decision using machine learning, in accordance with some embodiments of the disclosure. The illustrative method provided in FIG. 4 may be implemented by action prediction system 120 of FIG. 1.

The elements of FIG. 4 are presented in one arrangement. However, it should be understood that one or more elements of the process may be performed in a different order, in parallel, omitted entirely, and the like. The other elements in addition to those presented may be implemented and, in some examples, elements may be added to implement error-handling functions if exceptions occur, and the like.

At block 410, the method may provide a question. For example, action prediction system 120 may access the predetermined set of questions or questions received as triage data. the series of questions may be answerable by an observer of the motor vehicle. The questions may include, for example, whether the motor vehicle is drivable, whether fluids are leaking, whether airbags were deployed, or other questions that would need a visible observation and analysis of the motor vehicle.

At block 420, the method may receive a response to the question. For example, the response may comprise images or video data, vehicle data, telematics data, and triage data responding to a state of the motor vehicle determined by an observer of the motor vehicle.

At block 430, the method may determine the categories of the response, as discussed herein and by adaptive data processing engine 122 of action prediction system 120 in FIG. 1.

At block 440, the method may apply a trained machine learning model for the individual categories associated with the response. Various machine learning models may be used, including an image or video data machine learning model, a generative AI model, a vehicle data machine learning model, a telematics data machine learning model, and a triage data machine learning model. For example, the machine learning models and techniques may include classifiers, decision trees, neural networks, gradient boosting, and similar machine learning models and techniques. The machine learning models may be trained previously according to historical correspondences between examples of the inputs and outputs. The training may be supervised, unsupervised, or a combination thereof, and may continue between operations for the lifetime of the system. Outputs of the models may be used to train the models again, for example to improve their accuracy. The model may be trained and revised, as discussed with FIGS. 1-2.

The machine learning model may determine a confidence value associated with the category. Various illustrative examples of determining a categorization and a confidence score by applying a machine learning model are provided herein. For example, the output of the machine learning model may determine, in accordance with a confidence score, whether a first category of input data (e.g., image/video data) identify that the motor vehicle is considered a total loss or repairable for the first category. When the confidence score for that category exceeds a threshold value for the first category, the motor vehicle may be determined to be a total loss or repairable for the first category of data. In another example, the output of the machine learning model may determine, in accordance with a confidence score, whether a second category of input data (e.g., vehicle data) identify that the motor vehicle is considered a total loss or repairable for that second category. When the confidence score for the second category exceeds a threshold value for the second category, the motor vehicle may be determined to be a total loss or repairable for the second category of data. In another example, the output of the machine learning model may determine, in accordance with a confidence score, whether a third category of input data (e.g., telematics data) identify that the motor vehicle is considered a total loss or repairable for the third category. When the confidence score for that category exceeds a threshold value for the third category, the motor vehicle may be determined to be a total loss or repairable for the third category of data. In another example, the output of the machine learning model may determine, in accordance with a confidence score, whether a fourth category of input data (e.g., triage data) identify that the motor vehicle is considered a total loss or repairable for the fourth category. When the confidence score for that category exceeds a threshold value for the fourth category, the motor vehicle may be determined to be a total loss or repairable for the fourth category of data.

At block 450, the method may determine if there are additional categories associated with the response. If yes, the method may return to block 440. If no, the method may proceed to block 460.

At block 460, the method may determine a weighted decision that combines the categorization and the confidence score for the individual categories of the plurality of data.

At block 470, the method may combine the categories and confidence scores and compare them to a confidence threshold. If no, the method may return to block 410 to iteratively provide additional questions. If no, the method may proceed to block 480.

When the system iteratively provides additional questions, the predetermined set of questions may be iteratively adjusted by adaptive data processing engine 122 to narrow the range of responses from the observer of the motor vehicle and help increase accuracy of the response. The predetermined set of questions may be reduced to ten questions and reordered to ask more important questions earlier.

When the confidence threshold is compared with the weighted decision, the four categories may be combined and compared to the threshold. The confidence scores may have equal weights so that when the categorization for a majority of the categories is total loss and the corresponding confidence score for those categories exceeds a threshold value for each category, the weighted decision that combines the categorization and the confidence scores for each category of the plurality of data may also equal total loss (e.g., corresponding with the majority). In another example of equal weights, when the categorization for a majority of the categories is repairable (e.g., not total loss) and the corresponding confidence score for those categories exceeds a threshold value for each category, the weighted decision that combines the categorization and the confidence scores for each category of the plurality of data may also equal repairable (e.g., corresponding with the majority).

Other weighted decisions may be determined, such that one determination (e.g., categorization and confidence score) could outweigh or correspond with an increased weight in comparison with the other determinations. For example, a first category (e.g., image/video data) may be the default determination of total loss or repairable when the confidence score exceeds a threshold. In other examples, the first category (e.g., image/video data) may be the default determination of total loss or repairable only when the confidence scores of the other categories fail to exceed a threshold. In still other examples, the aggregation of the second category (e.g., vehicle data), third category (e.g., telematics data), and fourth category (e.g., triage data) may be used when the confidence score exceeds a threshold value for the first category (e.g., image/video data). Various implementation details are possible.

The weighted decision may be determined by votes. The votes may be configured to adjust one or more thresholds corresponding to each data category or determine which input categories are determinative of a total or partial loss, or a repairable component of the motor vehicle that does not exceed a total value of the motor vehicle.

The weighted decisions may correspond with a profile. The profile may be selectable or otherwise associated with a user operating the system. The profile may determine which category is weighted higher than other categories or other features, including the threshold value for each category or what requirements are needed to generate the ultimate weighted decision that combines the categorization and the confidence score for each category of the plurality of data.

At block 480, information associated with the weighted decision may be provided. For example, a graphical user interface (GUI) may display the information associated with the weighted decision. In some examples, the information associated with the weighted decision may be provided via the API gateway.

FIG. 5 are illustrative user interfaces for providing a display element associated with a weighted decision, in accordance with some embodiments of the disclosure. In these illustrations, the user interfaces may be graphical user interfaces (GUIs) provided at an output device 130 or vehicle 140. The user interface may comprise a display element that represents information associated with the weighted decision in various ways.

User interfaces 510, 520 provide the weighted decision in textual form. In these examples, first user interface 510 provides a total loss determination whereas second user interface 520 provides a repairable determination of the motor vehicle.

User interfaces 530, 540 provide the weighted decision in a chart format. In these examples, third user interface 530 shows the four categories of data and a particular category of data that exceeds a threshold in the determination of whether the motor vehicle is a total loss or repairable. The fourth user interface 540 shows the categories of data that are evenly weighted to highlight which category of data is more likely to identify the total loss of the motor vehicle.

User interface 550 provides the weighted decision as a heat map. For example, the components of the vehicle that are damaged by the motor vehicle accident may be provided to a user interface and overlay shade ranges or different colors (e.g., red for not repairable and green for repairable) in a heat map. The weighted decision may be displayed using colors to enable identification of areas of the motor vehicle that are repairable. When the entire vehicle corresponds with a loss determination in excess of a threshold value, the entire vehicle may be red or other shade that identifies a total loss.

User interface 560 provides the weighted decision with an identification of a borderline condition, including a “borderline repairable” decision or a “borderline total loss” decision. In this example, user interface 560 shows that the confidence score for one or more categories are within a threshold difference of the threshold value(s) for the categories. In other words, the confidence score for the first category may exceed a first threshold score (e.g., to determine a borderline condition for a total loss) but not exceed a second threshold score (e.g., to determine a definite condition for a total loss) for the first category. The borderline conditions may be combined for one or more categories (e.g., the second category may exceed a first threshold score for the second category but not exceed a second threshold score for the second category, the third category may exceed a first threshold score for the third category but not exceed a second threshold score for the third category, and so on).

User interface 570 provides the weighted decision (e.g., repairable or total loss) from the aggregated category data and a suggestion of what action to take with vehicle 140. In this example, although the suggestion is to repair the vehicle, the cost of the vehicle parts may exceed a threshold value and the suggestion may include accessing an after-market vehicle part through a third party marketplace.

User interface 580 provides an interactive display element that allows the user to select the profile to determine which weights or threshold values to use when determining the weighted decision. In this example, the graphical user interface includes a drop-down display element for the user to select the relevant profile.

The GUI can be provided to output device 130 or vehicle 140 of FIG. 1 to allow an adjuster user, for example, to obtain an automated indication regarding whether the vehicle damage is likely to render a total loss of the motor vehicle or a repairable operation of the motor vehicle resulting from the motor vehicle accident.

Functions and components described herein are not limiting. Those skilled in the art that the foregoing detailed disclosure will understand that the description is intended to be presented by way of example only. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

FIG. 6 depicts a block diagram of an example computer system 600 in which embodiments described herein may be implemented. Computer system 600 includes bus 602 or other communication mechanism for communicating information, one or more hardware processors 604 coupled with bus 602 for processing information. Hardware processor(s) 604 may be, for example, one or more general purpose microprocessors.

Computer system 600 also includes main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

Computer system 600 may be coupled via bus 602 to display 612, such as a liquid crystal display (LCD) (or touch screen), for displaying information to a computer user. Input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

Computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C, C++, Python, or PyTorch. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

Computer system 600 also includes network interface 618 coupled to bus 602. Network interface 618 provides a two-way data communication coupling to one or more network links that are connected to one or more local networks. For example, network interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or a WAN component to communicate with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 618, which carry the digital data to and from computer system 600, are example forms of transmission media.

Computer system 600 can send messages and receive data, including program code, through the network(s), network link and network interface 618. In the Internet example, a server might transmit a requested code for an application program through the Internet, the ISP, the local network and network interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method for automatically predicting repair or total loss actions in relation to a motor vehicle accident, the method comprising:
receiving, by an action prediction system, a plurality of data comprising one or more images or video of a motor vehicle involved in a motor vehicle accident, vehicle data describing categorization of the motor vehicle, telematics data recorded within a threshold of time of the motor vehicle accident, and triage data responding to a state of the motor vehicle determined by an observer of the motor vehicle;
initiating a data imputation process to supplement the plurality of data;
for individual categories of the plurality of data, determining a categorization and a confidence score by applying the plurality of data as input to a set of trained machine learning models for individual categories;
determining a weighted decision for individual categories that combines the categorization and the confidence score;
selecting a question of a set of questions based on the weighted decision and providing the question to a graphical user interface (GUI);
upon receiving a response to the question via the GUI, providing the response to the set of trained machine learning models, wherein output from the set of trained machine learning models iteratively adjusts the confidence score for each category and the weighted decision; and
when the weighted decision exceeds a confidence threshold, updating the GUI to present information associated with the weighted decision.

2. The method of claim 1, wherein the weighted decision aggregates the categorization and the confidence score for the individual categories.

3. The method of claim 1, wherein the weighted decision identifies a greatest value of the confidence score for the individual categories.

4. The method of claim 1, wherein the weighted decision identifies a repairable versus total loss vehicle damage classification.

5. The method of claim 1, wherein when the weighted decision exceeds the confidence threshold, updating the GUI to present a repairable vehicle damage classification.

6. The method of claim 1, wherein when the weighted decision exceeds the confidence threshold, updating the GUI to present a total loss vehicle damage classification.

7. The method of claim 1, wherein the categorization comprises damage triage questionnaire details, context driven image artifacts and/or video stream which infers damage recognition to various parts/panel of the vehicle, or vehicular metadata.

8. The method of claim 1, wherein the set of trained machine learning models for individual categories comprise at least two of machine learned, statistical, and image-based CV models that are trained on different datasets.

9. The method of claim 1, wherein the question is generated using Generative Artificial Intelligence (Generative AI) process.

10. The method of claim 1, wherein the individual categories comprise Repairable, Borderline repairable, Borderline total loss, and total loss.

11. The method of claim 1, further comprising:
receiving a rank order and weight of the individual categories that adjusts the weighted decision for the individual categories.

12. The method of claim 1, further comprising:
receiving a profile that adjusts the weighted decision for the individual categories.

13. The method of claim 1, further comprising:
comparing the weighted decision with a confidence margin threshold; and
based on the comparison, determine a second category associated with the weighted decision.

14. The method of claim 1, further comprising:
removing question-answer data from the input that is applied to the set of trained machine learning models for individual categories; and
supplementing determinations from the one or more image or video as the input that is applied to the set of trained machine learning models for individual categories.

15. An accident prediction system for automatically predicting repair or total loss actions in relation to a motor vehicle accident comprising:
a memory; and
a processor that is configured to execute machine readable instructions stored in the memory for causing the processor to:
receive a plurality of data comprising one or more images or video of a motor vehicle involved in a motor vehicle accident, vehicle data describing categorization of the motor vehicle, telematics data recorded within a threshold of time of the motor vehicle accident, and triage data responding to a state of the motor vehicle determined by an observer of the motor vehicle;
initiate a data imputation process to supplement the plurality of data;
for individual categories of the plurality of data, determine a categorization and a confidence score by applying the plurality of data as input to a set of trained machine learning models for individual categories;
determine a weighted decision for individual categories that combines the categorization and the confidence score;
select a question of a set of questions based on the weighted decision and providing the question to a graphical user interface (GUI);
upon receiving a response to the question via the GUI, provide the response to the set of trained machine learning models, wherein output from the set of trained machine learning models iteratively adjusts the confidence score for each category and the weighted decision; and
when the weighted decision exceeds a confidence threshold, update the GUI to present information associated with the weighted decision.

16. The accident prediction system of claim 15, wherein the weighted decision aggregates the categorization and the confidence score for the individual categories.

17. The accident prediction system of claim 15, wherein the weighted decision identifies a greatest value of the confidence score for the individual categories.

18. The accident prediction system of claim 15, wherein the weighted decision identifies a repairable versus total loss vehicle damage classification.

19. The accident prediction system of claim 15, wherein when the weighted decision exceeds the confidence threshold, updating the GUI to present a repairable vehicle damage classification.

20. The accident prediction system of claim 15, wherein when the weighted decision exceeds the confidence threshold, updating the GUI to present a total loss vehicle damage classification.
